(19) United States
(12) Patent Application Publication
(10) Pub. No.: US 2015/0077914 A1
(43) Pub. Date: Mar. 19, 2015

(54) ELECTRONIC PERIPHERAL AND ELECTRONIC DEVICE

(71) Applicant: Acer Incorporated, New Taipei City (TW)

(72) Inventors: Yi-Ta Huang, New Taipei City (TW); Cheng-Nan Ling, New Taipei City (TW); Wen-Chieh Tai, New Taipei City (TW); Yu-Shih Wang, New Taipei City (TW)

(73) Assignee: Acer Incorporated, New Tapei City (TW)

(21) Appl. No.: 14/164,275

(22) Filed: Jan. 27, 2014

(30) Foreign Application Priority Data
Sep. 18, 2013 (TW) 102133952

(51) Int. Cl. G06F 1/16

(52) U.S. Cl. CPC G06F 1/1684
USPC 361/679.4

(57) ABSTRACT

An electronic device adapted to be electrically connected to an electronic peripheral is provided. The electronic peripheral includes a main body and a plurality of peripheral pads. The peripheral pads are disposed on a corresponding surface of the main body. The electronic device includes a body and a plurality of device pads. The body includes a receiving surface. The device pads are disposed on the receiving surface. When the corresponding surface is disposed on the receiving surface and each of the peripheral pads is in contact with the corresponding device pad, the main body is electrically connected with the body.

### CROSS-REFERENCE TO RELATED APPLICATION

This application claims the priority benefit of Taiwan application serial no. 102133952, filed on Sep. 18, 2013. The entirety of the above-mentioned patent application is hereby incorporated by reference herein and made a part of this specification.

### BACKGROUND OF THE INVENTION

1. Field of the Invention

The invention relates to an electronic peripheral and an electronic device and in particular relates to an electronic peripheral and an electronic device that are electrically connected through pad contact.

2. Description of Related Art

Along with continual development of electronic technology in the recent years, user-friendly portable electronic devices with powerful functions have come forth and gradually replaced the old ones. For instance, notebook computers have gradually replaced desktop computers and become the mainstream in the 3C market. The portable electronic devices may refer to tablet computers and smart phones, etc. These devices are combined with touch-control interactive interfaces and are made thin and light for the user to carry around. Thus, they are quite popular in the market.

In terms of notebook computers, the periphery (the so-called coastline) of the host is usually provided with a variety of receptacle connectors, to which plug connectors with the corresponding specifications may be inserted to achieve data transmission or power transmission.

For the aforementioned purposes, the periphery of the host casing of the notebook computer needs to be slotted to expose the receptacle connectors. The slots on the host casing not only affect the overall appearance of the notebook computer but also impose restrictions on the exterior design. Moreover, for notebook computers that have high waterproof requirements, the slots on the host casing and the receptacle connectors installed therein both increase the difficulty in designing the waterproof mechanism.

### SUMMARY OF THE INVENTION

The invention provides an electronic peripheral that is adapted to be electrically connected to a corresponding electronic device through pad contact for data or power transmission.

The invention provides an electronic device that is adapted to be electrically connected to a corresponding electronic peripheral through pad contact for data or power transmission.

The invention provides an electronic peripheral adapted to be electrically connected to an electronic device. The electronic device includes a body and a plurality of device pads. The device pads are disposed on a receiving surface of the body. The electronic peripheral includes a main body and a plurality of peripheral pads. The main body has a corresponding surface. The peripheral pads are disposed on the corresponding surface. When the corresponding surface is placed on the receiving surface and each of the peripheral pads is in contact with the corresponding device pad, the main body is electrically connected with the body.

The invention provides an electronic device adapted to be electrically connected to an electronic peripheral. The electronic peripheral includes a main body and a plurality of peripheral pads. The peripheral pads are disposed on a corresponding surface of the main body. The electronic device includes a body and a plurality of device pads. The body has a receiving surface. The device pads are disposed on the receiving surface. When the corresponding surface is placed on the receiving surface and each of the peripheral pads is in contact with the corresponding device pad, the main body is electrically connected with the body.

Based on the above, the electronic device of the invention has the electronic peripheral corresponding thereto. The electronic device includes device pads disposed on the corresponding surface thereof, and the electronic peripheral includes the peripheral pads disposed on the receiving surface thereof corresponding to the device pads. When the user places the corresponding surface of the electronic peripheral on the receiving surface of the electronic device, the device pads come in contact with the peripheral pads, so as to electrically connect the main body with the body for data or power transmission. Since the electrical connection between the electronic peripheral and the electronic device of the invention is achieved by pad contact, flexibility in appearance design of the electronic device is increased, which is conducive to simplifying the waterproof design of the electronic device.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A is a schematic diagram depicting an electronic peripheral being separated from an electronic device according to an embodiment of the invention.

FIG. 1B is a schematic diagram depicting assembly of the electronic peripheral and the electronic device of FIG. 1A.

FIG. 2A and FIG. 2B are partial schematic diagrams depicting peripheral pads in contact with device pads according to other embodiments of the invention.

FIG. 3A is a schematic diagram depicting a section A of FIG. 1.

FIG. 3B to FIG. 3F are schematic cross-sectional diagrams depicting peripheral pads in contact with device pads according to other embodiments of the invention.

### DESCRIPTION OF THE EMBODIMENTS

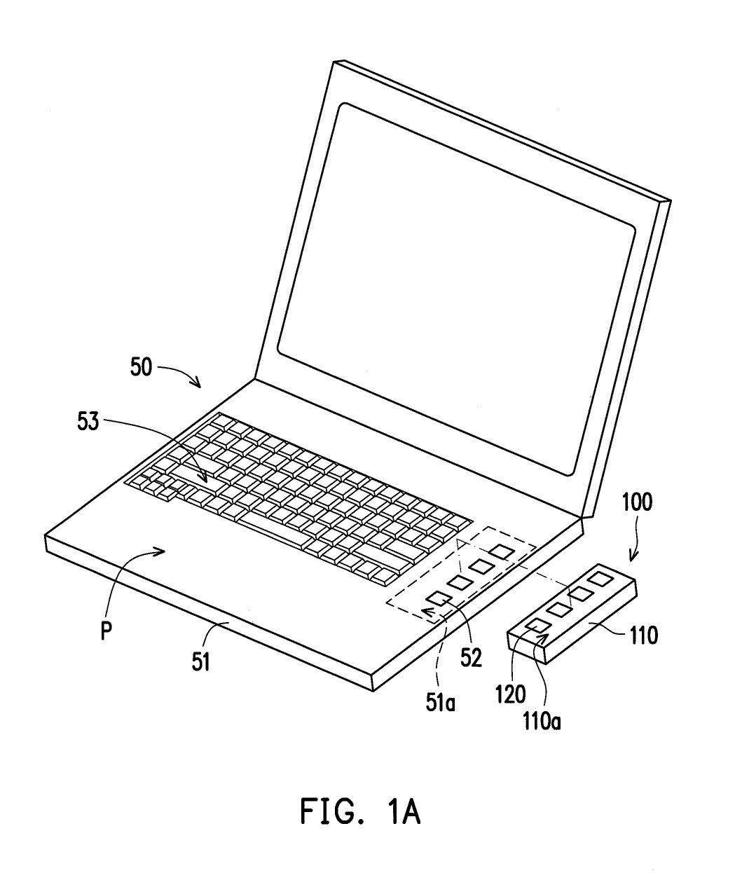

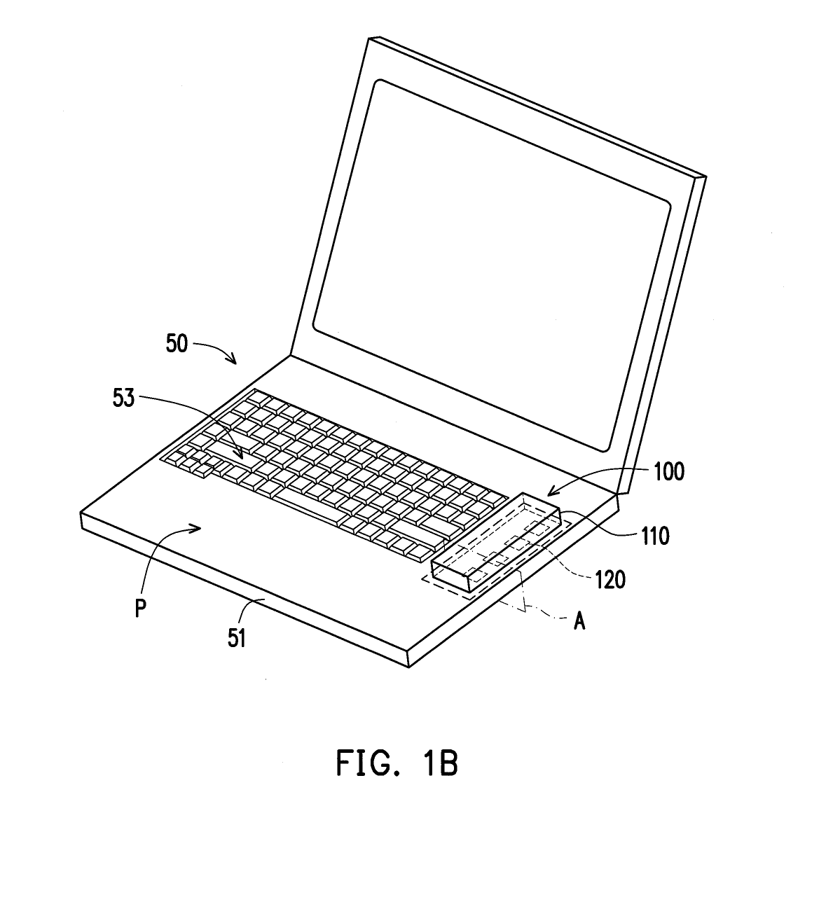

FIG. 1A is a schematic diagram depicting an electronic peripheral being separated from an electronic device according to an embodiment of the invention. FIG. 1B is a schematic diagram depicting assembly of the electronic peripheral and the electronic device of FIG. 1A. With reference to FIG. 1A and FIG. 1B, in this embodiment, an electronic device 50 is adapted to be electrically connected to an electronic peripheral 100, wherein the electronic device 50 is a notebook computer, a tablet computer, or a smart phone, for example; however, the invention is not limited thereto. The electronic peripheral 100 is an electrical connector or portable data storage media, for example; however, the invention is not limited thereto, either.

The electronic device 50 includes a body 51 and a plurality of device pads 52. The body 51 has a receiving surface 51a. More specifically, the receiving surface 51a is a partial region of an operating plane P of the body 51, for example. A notebook computer is given as an example in this embodiment, and thus the operating plane P may be defined as a plane having a keyboard 53.

In this embodiment, the device pads 52 are disposed on the receiving surface 51a. The electronic peripheral 100 includes a main body 110 and a plurality of peripheral pads 120. The peripheral pads 120 are disposed on a corresponding surface 110a of the main body 110. When the electronic peripheral 100 is assembled with the electronic device 50, the corresponding surface 110a is placed on the receiving surface 51a and each of the peripheral pads 120 is in contact with the corresponding device pad 52, so as to electrically connect the main body 110 with the body 51.

To be more specific, the number of the device pads 52 is equal to the number of the peripheral pads 120. This embodiment illustrates a situation that four device pads 52 and four peripheral pads 120 are provided; however, the invention is not limited thereto. The numbers of the device pads 52 and the peripheral pads 120 may be varied as required. In addition, the device pads 52 are metal electrodes electrically connected with the body 51, and the peripheral pads 120 are metal electrodes electrically connected with the main body 110.

In this embodiment, the device pads 52 and the peripheral pads 120 may be rectangular patterns having equal areas. Therefore, when the receiving surface 110a is placed on the corresponding surface 51a to dispose each of the peripheral pads 120 in contact with the corresponding device pad 52, the peripheral pads 120 are completely in contact with the device pads 52, so as to ensure the electrical connection between the main body 110 and the body 51 for data or power transmission. The contact between the peripheral pads 120 and the device pads 52 is used to replace the plugging of the traditional receptacle connectors and plug connectors. Thus, it is not required to develop a complicated waterproof design for the traditional receptacle connectors, and therefore the waterproof design for the electronic device 50 is simplified.

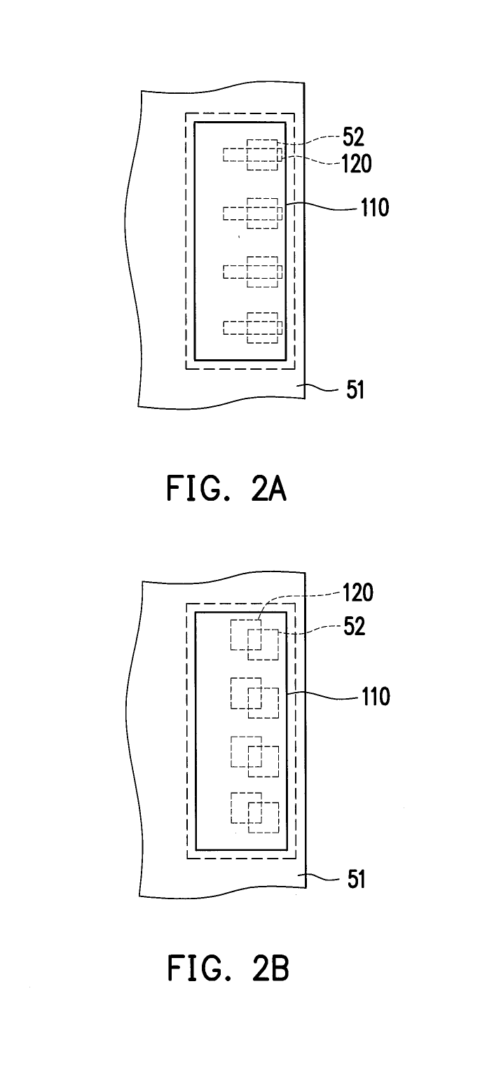

FIG. 2A and FIG. 2B are partial schematic diagrams depicting peripheral pads in contact with device pads according to other embodiments of the invention. As shown in FIG. 2A and FIG. 2B, when operated by a user, inaccurate placement or influence of other external forces may cause a displacement between the peripheral pads 120 and the device pads 52. However, stability of the data or power transmission can still be effectively maintained if at least a portion of the peripheral pads 120 is in contact with at least a portion of the corresponding device pads 52.

In other words, if it is possible to ensure that at least a portion of the peripheral pads 120 remains in contact with at least a portion of the corresponding device pads 52 without affecting the stability of the data or power transmission, the patterns of the device pads 52 and the peripheral pads 120 may be designed to have different areas or different shapes. The above disclosure is not intended to limit the areas or shapes of these elements.

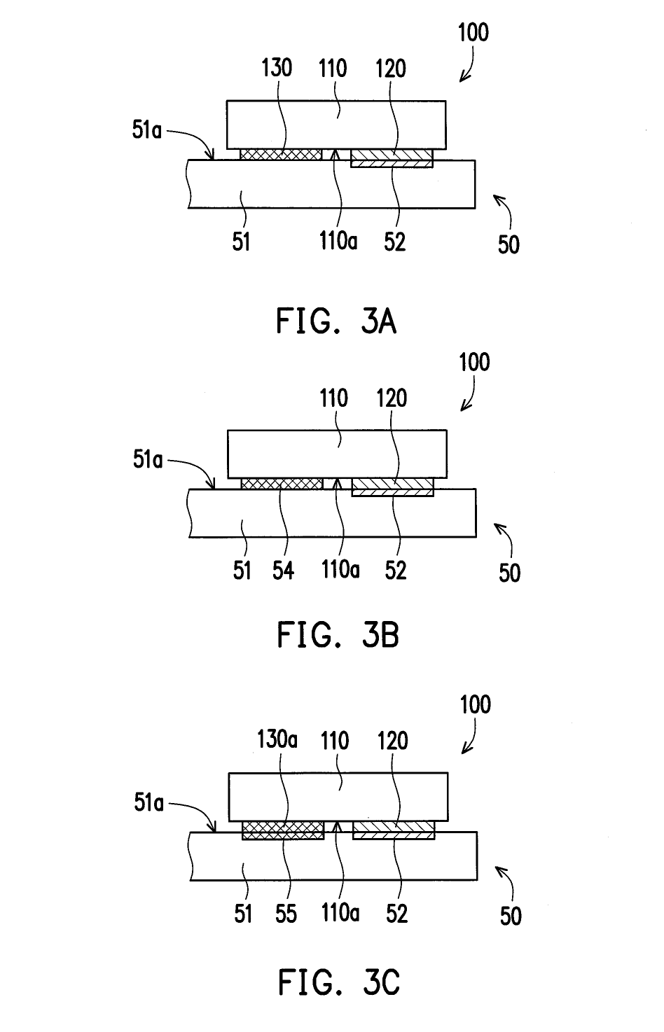

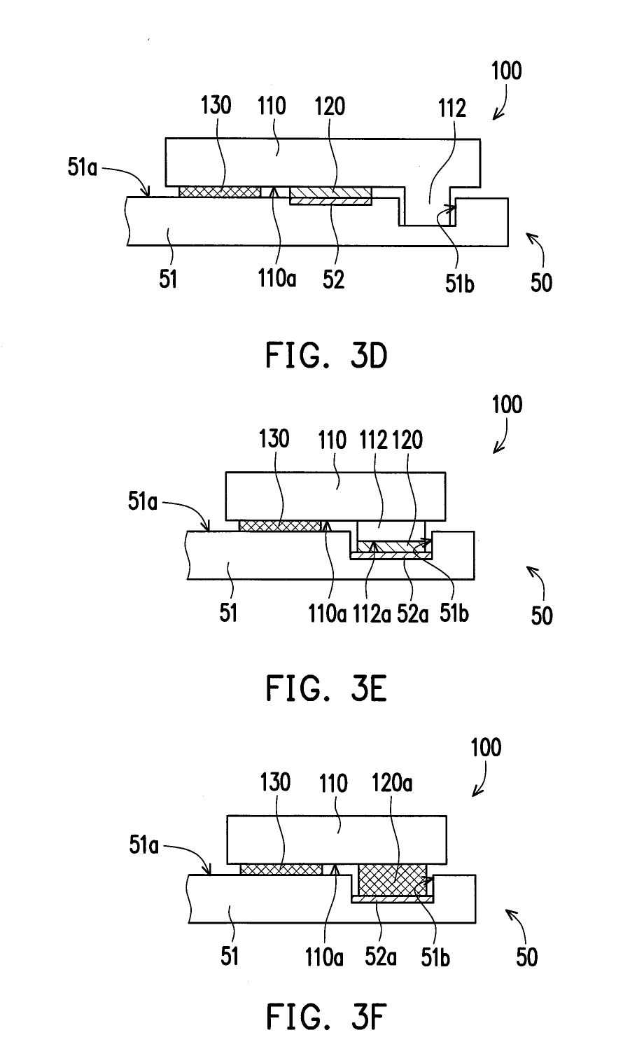

FIG. 3A is a schematic diagram depicting a section A of FIG. 1. Referring to FIG. 3A, in this embodiment, the electronic peripheral 100 further includes a suction member 130. The suction member 130 is fixed on the main body 110. The suction member 130 is disposed on the corresponding surface 110a of the main body 110 and located on the same side as the peripheral pads 120. More specifically, the suction member 130 is a sucker (or even a nano-sucker), for example, wherein the nano-sucker refers to a vacuum sucker that is very small in size, and a plurality of the nano-suckers may be arranged for use together. Therefore, when the user places the corresponding surface 110a of the main body 110 to be in contact with the receiving surface 51a of the body 51, the suction member 130 is tightly adhered to the receiving surface 51a so as to attach the main body 110 to the body 51, thereby ensuring the contact between the peripheral pads 120 and the corresponding device pads 52 to improve the stability of the data or power transmission.

FIG. 3B to FIG. 3F are schematic cross-sectional diagrams depicting peripheral pads in contact with device pads according to other embodiments of the invention. With reference to FIG. 3B, the electronic device 50 further includes a suction member 54, wherein the suction member 54 is for example a nano-sucker that is the same as or similar to the suction member 130. Therefore, when the user places the corresponding surface 110a of the main body 110 to be in contact with the receiving surface 51a of the body 51, the suction member 54 is tightly adhered to the corresponding surface 110a, so as to attach the main body 110 to the body 51, thereby ensuring the contact between the device pads 52 and the corresponding peripheral pads 120 to improve the stability of the data or power transmission.

With reference to FIG. 3C, in this embodiment, the suction member is a first magnetic member 130a, and the body 51 includes at least one second magnetic member 55 that is attracted to the first magnetic member 130a. The second magnetic member 55 is disposed on the receiving surface 51a of the body 51 and is located on the same side as the device pads 52. Generally, the first magnetic member 130a and the second magnetic member 55 are equal in number and are disposed corresponding to each other. Therefore, when the user places the corresponding surface 110a of the electronic peripheral 120 to be in contact with the receiving surface 51a of the body 51, the main body 110 is assembled to the body 51 by attraction between the first magnetic member 130a and the second magnetic member 55, so as to ensure the contact between the peripheral pads 120 and the corresponding device pads 52 after the corresponding surface 110a is placed on the receiving surface 51a.

With reference to FIG. 3D, in this embodiment, the main body 110 includes at least one protrusion 112 that protrudes from the corresponding surface 110a, and the body 51 includes at least one recess 51b that is recessed on the receiving surface 51a. When the corresponding surface 110a is placed on the receiving surface 51a with the protrusion 112 inserted into the recess 51b, each of the peripheral pads 120 is in contact with the corresponding device pad 52. In other words, the protrusion 112 and the recess 51b of this embodiment are positioning structures that correspond to each other for the user to ensure the contact between the peripheral pads 120 and the corresponding device pads 52 after placing the corresponding surface 110a on the receiving surface 51a without paying special attention to the positioning.

With reference to FIG. 3E, in this embodiment, each of the peripheral pads 120 is disposed on a top surface 112a of the corresponding protrusion 112, and each of the device pads 52a is located in the corresponding recess 51b. Therefore, when the corresponding surface 110a is placed on the receiving surface 51a, each protrusion 112 is inserted into the corresponding recess 51b, such that the peripheral pad 120a on the protrusion 112 is in contact with the corresponding device pad 52a in the recess 51b. With the aforementioned configuration, the pads and the positioning structures are combined, and the contact between the peripheral pads 120 and the corresponding device pads 52a is also ensured.

With reference to FIG. 3F, in this embodiment, the peripheral pads 120a serve as a plurality of protrusions. That is to say, the peripheral pads 120a are metal bumps bonded to the main body 110, for example. Each of the device pads 52a is located in the corresponding recess 51b. When the corresponding surface 110a is placed on the receiving surface 51a, each of the peripheral pads 120a is inserted into the corresponding recess 51b to be in contact with the corresponding device pad 52a. In other words, the peripheral pads 120a of this embodiment are the positioning structures corresponding to the recesses 51b. When each of the peripheral pads 120a is inserted into the corresponding recess 51b, the contact between the peripheral pads 120 and the corresponding device pads 52a is ensured.

To sum up, the electronic device of the invention has the electronic peripheral corresponding thereto. The electronic device includes device pads disposed on the corresponding surface thereof, and the electronic peripheral includes the peripheral pads disposed on the receiving surface thereof corresponding to the device pads. When the user places the corresponding surface of the electronic peripheral on the receiving surface of the electronic device, the device pads come in contact with the peripheral pads, so as to electrically connect the main body with the body for data or power transmission. Since the electrical connection between the electronic peripheral and the electronic device of the invention is achieved by pad contact, flexibility in appearance design of the electronic device is increased, which is conducive to simplifying the waterproof design of the electronic device.

Moreover, at least one of the electronic peripheral and the electronic device includes the suction member that is disposed on the corresponding surface of the electronic peripheral or the receiving surface of the electronic device. After the user places the corresponding surface on the receiving surface, the corresponding surface and the receiving surface are stably connected by the suction member to ensure the contact between the peripheral pads and the corresponding device pads, thereby improving the stability of data or power transmission.

It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. An electronic peripheral adapted to be electrically connected to an electronic device that comprises a body and a plurality of device pads disposed on a receiving surface of the body, the electronic peripheral comprising:
a main body comprising a corresponding surface; and
a plurality of peripheral pads disposed on the corresponding surface, wherein when the corresponding surface is placed on the receiving surface and each of the peripheral pads is in contact with the corresponding device pad, the main body is electrically connected with the body.

2. The electronic peripheral according to claim 1, further comprising:
at least a suction member fixed on the main body to attach the main body to the body.

3. The electronic peripheral according to claim 2, wherein the suction member is a first magnetic member, and the body comprises at least a second magnetic member that is attracted to the first magnetic member, the second magnetic member is disposed on the receiving surface of the body and located on the same side as the device pads, and the main body is assembled to the body by attraction between the first magnetic member and the second magnetic member.

4. The electronic peripheral according to claim 1, wherein the main body comprises at least a protrusion that protrudes from the corresponding surface, and when the corresponding surface is placed on the receiving surface with the protrusion inserted into at least a corresponding recess on the receiving surface, each of the peripheral pads is in contact with the corresponding device pad.

5. The electronic peripheral according to claim 4, wherein the peripheral pads serve as a plurality of the protrusions, and the corresponding device pads are located in the recess, and when the corresponding surface is placed on the receiving surface, each of the peripheral pads is inserted into the corresponding recess to be in contact with the corresponding device pad.

6. An electronic device adapted to be electrically connected to an electronic peripheral that comprises a main body and a plurality of peripheral pads disposed on a corresponding surface of the main body, the electronic device comprising:
a body comprising a receiving surface; and
a plurality of device pads disposed on the receiving surface, wherein when the corresponding surface is placed on the receiving surface and each of the peripheral pads is in contact with the corresponding device pad, the main body is electrically connected with the body.

7. The electronic device according to claim 6, further comprising:
at least a suction member fixed on the body to attach the main body to the body.

8. The electronic device according to claim 7, wherein the suction member is a first magnetic member, and the body comprises at least a second magnetic member that is attracted to the first magnetic member, the second magnetic member is disposed on the receiving surface of the body and located on the same side as the device pads, and the main body is assembled to the body by attraction between the first magnetic member and the second magnetic member.

9. The electronic device according to claim 6, wherein the body comprises at least a recess that is recessed on the receiving surface, and when the corresponding surface is placed on the receiving surface with at least a corresponding protrusion on the corresponding surface inserted into the recess, each of the peripheral pads is in contact with the corresponding device pad.

10. The electronic device according to claim 9, wherein the peripheral pads serve as a plurality of the protrusions, and the corresponding device pads are located in the corresponding recess, and when the corresponding surface is placed on the receiving surface, each of the peripheral pads is inserted into the corresponding recess to be in contact with the corresponding device pad.
